(19) United States
(12) Patent Application Publication
(10) Pub. No.: US 2010/0153079 A1
(43) Pub. Date: Jun. 17, 2010

(54) METHOD OF MODELING CAPACITOR MISMATCH

(76) Inventor: Jung-Hyun Choi, Gangnam-gu (KR)

Correspondence Address: SHERR & VAUGHN, PLLC, 620 HERNDON PARKWAY, SUITE 320, HERNDON, VA, 20170, US

(21) Appl. No.: 12/634,200

(22) Filed: Dec. 9, 2009

(30) Foreign Application Priority Data
Dec. 16, 2008 (KR) 10-2008-0127705

(51) Int. Cl. G06F 17/10

(52) U.S. Cl. 703/2

(57) ABSTRACT

A method of modeling mismatch of capacitors and devices thereof. Unlike methods of only performing a measurement of capacitor mismatch using a floating gate technique, a method of modeling mismatch may include constructing an analog circuit having capacitors including a different ratio and/or size, and/or measuring capacitor mismatch values. A method of modeling mismatch may include extracting modeling parameters by applying measured mismatch values to a mismatch model, and/or calculating actual capacitor mismatch values by applying extracted modeling parameters and/or a ratio and/or size of actual capacitors to be modeled to a mismatch model. It may be possible to detect characteristics of an analog circuit based on calculated and/or actual capacitor mismatch values.

The present application claims priority under 35 U.S.C. 119 to Korean Patent Application No. 10-2008-0127705 (filed on Dec. 16, 2008) which is hereby incorporated by reference in its entirety.

### BACKGROUND

Embodiments relate to a method of modeling capacitor mismatch, and devices thereof.

An analog to digital converter (ADC), a digital to analog converter (DAC), and the like, may be important in the design of an analog circuit, and/or may use a metal-insulator-metal capacitor (MN capacitor) to convert an analog signal to a digital signal after dividing it by a certain unit of bit, and vice versa. Such signal conversion may require measurement of a mismatch of a MN capacitor for analysis of a characteristic of an analog circuit. One method that may be used may include directly measuring capacitance through AC measurement to an MIM capacitor and comparing the measured capacitance with mismatch of a MIM capacitor. Another method that may be used may include indirectly measuring mismatch of an MIM capacitor using a floating gate technique based on DC measurement to a MIM capacitor.

However, in the above two methods, the mismatches of a MIM capacitor may show a characteristic and/or a limitation of an analog circuit. While it may be difficult for the former method to correctly find correct mismatch of a MIM capacitor, due to an error of AC measuring equipment, the latter method may have a relatively small error from measuring equipment since it measures mismatch of a MIM capacitor using a potential difference produced by applying a DC voltage to capacitors with substantially the same ratio. Accordingly, the latter method may be used for a mismatch of a MIM capacitor, and/or a standard deviation measured may reference a mismatch, which may be inversely proportional to a capacitor area.

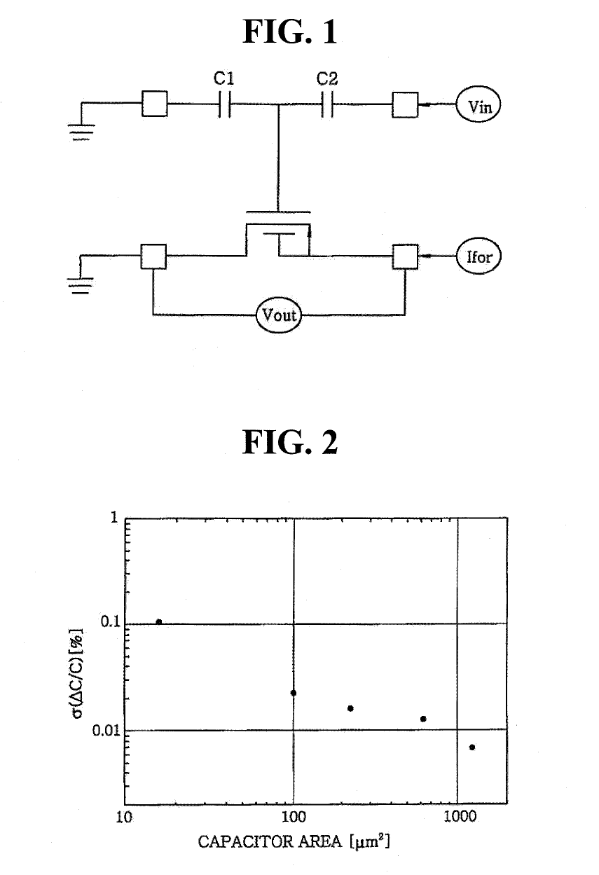

Example FIG. 1 is a view illustrating measurement of a mismatch of a MIM capacitor using a floating gate technique. Example FIG. 2 is a view illustrating measurement values for mismatch of a MIM capacitor, which may be obtained when a floating gate technique may be used. Referring to example FIG. 1, capacitors C1 and C2 may have the same ratio, and/or may be disposed in parallel. A P-type MOSFET may be connected between capacitors C1 and C2, and/or terminals to apply a voltage may be connected to capacitors C1 and C2. When a metal oxide field effect transistor (MOSFET) performs a source follower operation by applying a current to a source terminal of a MOSFET and grounding a drain terminal of a MOSFET, a varying voltage applied to capacitors may be reflected in a gate terminal of a MOSFET which may be output at a source terminal.

Referring to FIG. 2, a standard deviation with respect to a capacitor area may be obtained. The standard deviation may be inversely proportional to capacitor area, and/or capacitors which may have the same ratio may have a mismatch. As described above, since measurement of a mismatch of a MIM capacitor using a floating technique may only show a mismatch of capacitors having the same ratio, and/or may check only a variation rate of mismatch with respect to a capacitor area, a precise mismatch may not be known in a circuit including capacitors having, for example, a different ratio and/or size.

Accordingly, there is a need of a method of modeling capacitor mismatch, and devices thereof, for example which may be adapted to model a mismatch characteristic of a capacitor constituting an analog circuit.

### SUMMARY

Embodiments relate to a method of modeling capacitor mismatch, and devices thereof. According to embodiments, a method of modeling mismatch of capacitors may be capable of measuring and/or modeling mismatch of MIM capacitors having a different ratio and/or size. In embodiments, a method of modeling mismatch of capacitors may be capable of measuring and/or modeling mismatch of poly-insulator-poly (PIP) capacitors having a different ratio and/or size.

According to embodiments, a method of modeling capacitor mismatch may include constructing an analog circuit having capacitors a different ratio and/or size, and/or measuring capacitor mismatch values. In embodiments, a method of modeling capacitor mismatch may include calculating a mismatch model and/or extracting modeling parameters based on measured capacitor mismatch values, and/or a ratio and/or size of capacitors. In embodiments, a method of modeling capacitor mismatch may include calculating actual capacitor mismatch values by applying extracted modeling parameters, and/or ratio and/or size of actual capacitors to be modeled, to the mismatch model.

Unlike methods performing a measurement of capacitor mismatch using a floating gate technique, embodiments may include constructing an analog circuit including capacitors having a different ratio and/or size, and/or measuring capacitor mismatch values, extracting modeling parameters by applying a measured mismatch values to a mismatch model, and/or calculating actual capacitor mismatch values by applying an extracted modeling parameters and/or a ratio and/or size of actual capacitors to be modeled to a mismatch model. Accordingly, it may be possible to detect characteristics of an analog circuit based on calculated actual capacitor mismatch values. In embodiments, it may be possible to model a ratio and/or size of capacitors in compliance with characteristics of an analog circuit.

### DRAWINGS

Example FIG. 1 is a view illustrating measurement of mismatch of a MIM capacitor using a floating gate technique.

Example FIG. 2 is a view illustrating measurement values for mismatch of a MIM capacitor obtained using a floating gate technique.

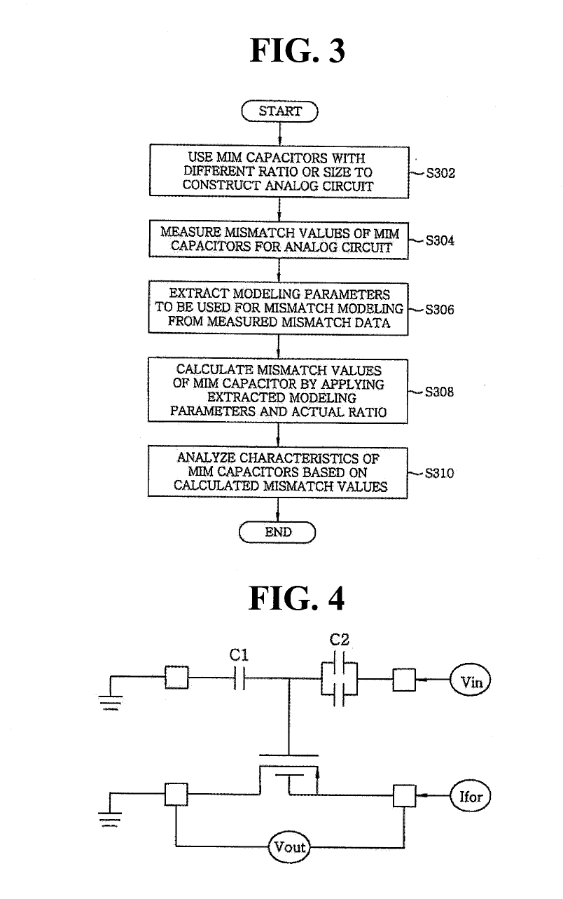

Example FIG. 3 is a flow chart illustrating a method of modeling mismatch of a MIM capacitor in accordance with embodiments.

Example FIG. 4 is a view illustrating an analog circuit including MIM capacitors having a different ratio and/or size in accordance with embodiments.

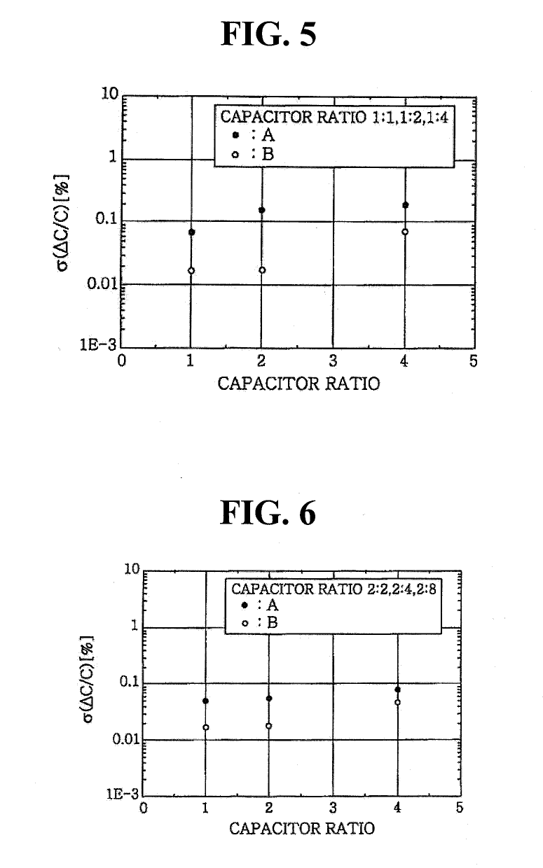

Example FIG. 5 is a view illustrating measurement of mismatch of MIM capacitors including ratios of approximately 1:1, 1:2 and/or 1:4 in accordance with embodiments.

Example FIG. 6 is a view illustrating measurement of mismatch of MIM capacitors including ratios of approximately 2:2, 2:4 and/or 2:8 in accordance with embodiments.

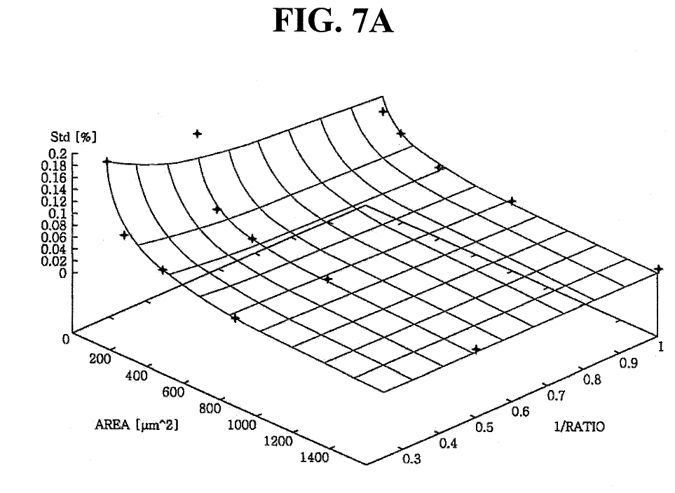

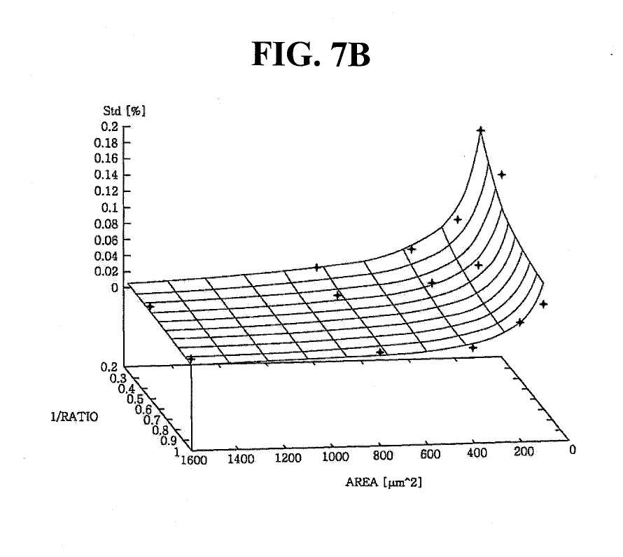

Example FIG. 7A to FIG. 7B are views illustrating a result of modeling mismatch of MIM capacitors in accordance with embodiments.

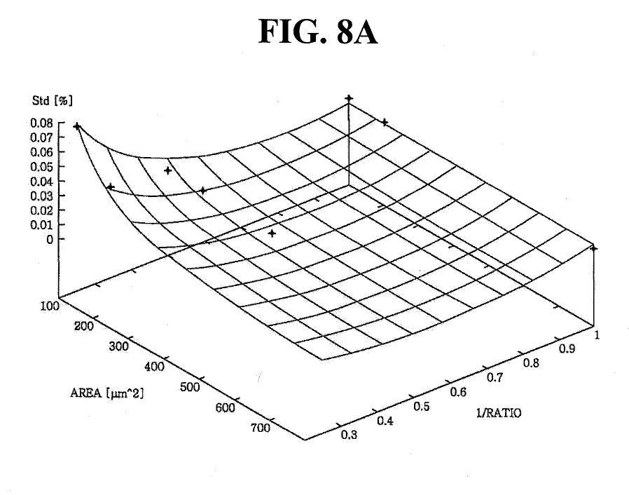

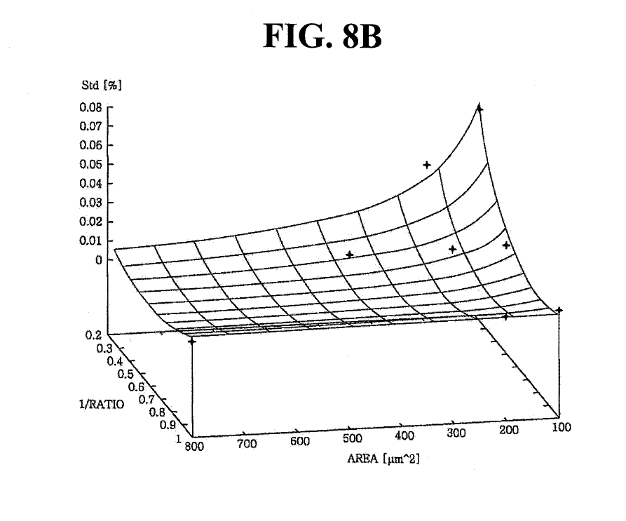

Example FIG. 8A to FIG. 8B are views illustrating a result of modeling mismatch of MIM capacitors in accordance with embodiments.

### DESCRIPTION

Embodiments relate to a method of modeling capacitor mismatch, and devices thereof. According to embodiments, it may be possible to calculate a capacitor mismatch value and/or effectively analyze characteristics of an analog circuit based on modeling parameters extracted from a mismatch value measured in an analog circuit having MIM capacitors including a different ratio and/or size, and/or actual ratio and/or size of a MIM capacitors of an analog circuit. Referring to example FIG. 3, a flow chart illustrates a method of modeling mismatch of MIM capacitors in accordance with embodiments. According to embodiments, MIM capacitors including a different ratio and/or size may be used to construct an analog circuit such as, for example, an ADC, a DAC, etc, as illustrated for example in Step S302.

Referring to example FIG. 4, a view illustrates an example analog circuit using MIM capacitors including a different ratio and/or size in accordance with embodiments. According to embodiments, an analog circuit may be a circuit for implementing approximately a 1:2 mismatch of MIM capacitors. In embodiments, a ratio of MIM capacitors may be varied in various manners such as approximately 1:1, 1:2, 1:4, etc. Referring back to FIG. 3, mismatch values of MIM capacitors for an analog circuit constructed in various manners may be measured by, for example, a floating gate technique and the like, as illustrated in Step S304.

Referring to example FIG. 5, a view illustrates an example of measurement of mismatch of MIM capacitors including ratios of approximately 1:1, 1:2 and/or 1:4 in accordance with embodiments. Referring to example FIG. 6, a view illustrates an example measurement of mismatch of MIM capacitors including ratios of approximately 2:2, 2:4 and/or 2:8 in accordance with embodiments. According to embodiments, a standard deviation, for example a mismatch value, on a y axis may increase as a ratio increases. In embodiments, a comparison of FIG. 5 and FIG. 6 illustrates that a mismatch illustrated in FIG. 6 may be lowered as a whole, for example when a size of MIM capacitors as illustrated in FIG. 6 may be approximately two times a size of MIM capacitors as illustrated in FIG. 5. In embodiments, mismatch may decrease as a basic array increases in size, that is, as a size of capacitors increases. In embodiments, A may refer to one process project and B may refer to a temporarily different process project.

Referring back to FIG. 3, modeling parameters to be used for mismatch modeling may be extracted from measured mismatch data, for example mismatch values, as illustrated in Step S306. According to embodiments, using a size and/or ratio of MIM capacitors, modeling parameters, for example A_{T}, A_{A} and/or A_{P}, may be extracted based on a standard deviation, for example mismatch values, of an analog circuit including MIM capacitors having a different ratio and/or size through a mismatch model. In embodiments, a mismatch model may include Equation 1.

$$σ ( \frac{Δ C}{C} ) = \frac{{A}_{T}}{W \cdot L \cdot {Ratio}^{- 1}} + \frac{{A}_{A}}{W \cdot L} + exp ( \frac{{A}_{R}}{{Ratio}^{- 1}} ) \qquad Equation 1$$

According to embodiments,

$$σ ( \frac{Δ C}{C} )$$

may refer to a standard deviation, for example a mismatch value, of MIM capacitors. In embodiments, W may refer to a width of MIM capacitors. In embodiments, L may refer to a length of MIM capacitors. In embodiments, Ratio may relate to a ratio of MIM capacitor. In embodiments, A_{T}, A_{A} and/or A_{P}, which may be extracted parameters, may refer to a total constant, an area constant and a ratio constant, respectively.

According to embodiments, mismatch values, for example a standard deviation, of MIM capacitor may be calculated by applying extracted modeling parameters and/or actual ratio, width, length, etc. of MIM capacitors constituting an analog circuit to be modeled to Equation 1, as illustrated in Step S308. In embodiments, characteristics of MIM capacitors may be analyzed based on calculated mismatch values, as illustrated in Step S310. Referring to example FIG. 7A to FIG. 7B, views illustrate a result of modeling mismatch of MIM capacitors in a process project in accordance with embodiments. Referring to example FIG. 8A to FIG. 8B, views illustrate a result of modeling mismatch of MIM capacitors in a process project in accordance with embodiments.

According to embodiments, a process dispersion may be changed due to a temporal difference between one process project and another process project, and/or there may occur a difference in trend between both process projects. In embodiments, characteristics of an analog circuit may be analyzed by applying a mismatch model in accordance with embodiments irrespective of such a difference in trend. In embodiments, points illustrated in FIG. 7 and/or FIG. 8 may reference actual measurement values and/or solid lines may reference modeled values. In embodiments, characteristics of an analog circuit may be effectively analyzed by calculating capacitor mismatch values based on modeling parameters extracted from mismatch values measured in an analog circuit including MIM capacitors having a different ratio and/or size, and/or actual ratio and/or size of MIM capacitors of an analog circuit to be modeled.

According to embodiments, characteristics of an analog circuit including PIP capacitors may be analyzed. In embodiments, characteristics of an analog circuit including PIP capacitors may be analyzed applying a mismatch model to an analog circuit including PIP capacitors having a different ratio and/or size.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A method comprising:
constructing an analog circuit including capacitors having at least one of a different ratio and size;
measuring capacitor mismatch values;
calculating a mismatch model and extracting modeling parameters based on said measured capacitor mismatch values and said at least one of the different ratio and size; and
calculating actual capacitor mismatch values of actual capacitors to be modeled to said mismatch model by applying said extracted modeling parameters and said at least one of the different ratio and size.

2. The method of claim 1, wherein the capacitors and said actual capacitors comprise metal-insulator-metal capacitors.

3. The method of claim 1, wherein the capacitors and said actual capacitors comprise poly-insulator-poly capacitors.

4. The method of claim 1, wherein said analog circuit comprises an analog to digital converter circuit.

5. The method of claim 1, wherein said analog circuit comprises a digital to analog converter circuit.

6. The method of claim 1, wherein said capacitor mismatch values are measured comprising a floating gate technique.

7. The method of claim 1, wherein said mismatch model comprises at least one of said modeling parameters, a capacitor ratio, a capacitor width and a capacitor length.

8. The method of claim 7, wherein said modeling parameters comprises at least one of:
a total constant corresponding to said capacitor ratio, capacitor width and capacitor length;
an area constant corresponding to said capacitor width and capacitor length; and
a ratio constant corresponding to said capacitor ratio.

9. The method of claim 7, comprising:
forming a first conductivity type metal oxide semiconductor field effect transistor connected between the capacitors; and
terminals configured to apply a voltage connected to the capacitors.

10. The method of claim 9, wherein said first conductivity type comprises a P type.

11. An apparatus comprising modeled capacitors having at least one of a different modeled ratio and size in compliance with the characteristics of a circuit, wherein said modeled capacitors are modeled by a method comprising:
constructing an analog circuit including capacitors having at least one of a different ratio and size;
measuring capacitor mismatch values;
calculating a mismatch model and extracting modeling parameters based on said measured capacitor mismatch values and said at least one of the different ratio and size; and
calculating actual capacitor mismatch values of actual capacitors to be modeled to said mismatch model by applying said extracted modeling parameters and said at least one of the different ratio and size.

12. The apparatus of claim 11, wherein the capacitors and said actual capacitors comprise metal-insulator-metal capacitors.

13. The apparatus of claim 11, wherein the capacitors and said actual capacitors comprise poly-insulator-poly capacitors.

14. The apparatus of claim 11, wherein said analog circuit comprises an analog to digital converter circuit.

15. The apparatus of claim 11, wherein said analog circuit comprises a digital to analog converter circuit.

16. The apparatus of claim 11, wherein said capacitor mismatch values are measured comprising a floating gate technique.

17. The apparatus of claim 11, wherein said mismatch model comprises at least one of said modeling parameters, a capacitor ratio, a capacitor width and a capacitor length.

18. The apparatus of claim 17, wherein said modeling parameters comprises at least one of:
a total constant corresponding to said capacitor ratio, capacitor width and capacitor length;
an area constant corresponding to said capacitor width and capacitor length; and
a ratio constant corresponding to said capacitor ratio.

19. The apparatus of claim 11, comprising:
a first conductivity type metal oxide semiconductor field effect transistor connected between the capacitors; and
terminals configured to apply a voltage connected to the capacitors.

20. The apparatus of claim 19, wherein said first conductivity type comprises a P type.
